(19) United States
(12) Patent Application Publication
(10) Pub. No.: US 2019/0288435 A1
(43) Pub. Date: Sep. 19, 2019

(54) CONNECTOR HAVING SOLDERLESS CONTACTS

(71) Applicant: 3M INNOVATIVE PROPERTIES COMPANY, St. Paul, MN (US)

(72) Inventors: Kok Hoe Lee, Singapore (SG); Saujit Bandhu, Singapore (SG); Chin Hua Lim, Singapore (SG); Rao L. Vittapalli, Singapore (SG); YunLong Qiao, Singapore (SG)

(21) Appl. No.: 16/462,567

(22) PCT Filed: Dec. 18, 2017
(86) PCT No.: PCT/IB2017/058071

§ 371 Date: May 21, 2019

Related U.S. Application Data
(60) Provisional application No. 62/437,751, filed on Dec. 22, 2016.

(51) Int. Cl. H01R 13/41; H01R 12/77; H01R 13/24; H01R 12/70; H01R 13/6597; H01R 13/66; H01R 13/6583

(52) U.S. Cl. CPC H01R 13/41; H01R 12/777; H01R 13/2442; H01R 12/62; H01R 13/6597; H01R 13/665; H01R 13/6583; H01R 12/7082

(57) ABSTRACT

An electrically conductive contact of an electrical connector includes an L-shaped main body comprising first and second legs connected at a junction. The first leg is configured to make physical and electrical contact with a first electric conductor. The contact includes an elongated resiliently flexible arm extending from an end of the second leg toward the junction and making an acute angle with the second leg at the end of the second leg. The flexible arm is configured to make solderless contact with a second electric conductor by pressing against the second electric conductor and resiliently flexing toward the second leg.

### TECHNICAL FIELD

This application relates to contacts for electrical connectors and to electrical connectors and electrical connector assemblies that incorporate such contacts.

### BACKGROUND

Electrical connectors are electro-mechanical devices typically including some type of mechanical housing supporting and/or partially enclosing electrical contacts. Electrical connectors are frequently used to electrically interconnect two or more electronic components. Typically a wire-to-board interconnect includes a connector pair comprising a plug connector and a receptacle connector in the mated position. Either the plug connector or the receptacle connector of the connector pair is mounted onto a printed circuit board (PCB) while the corresponding mating connector from the same pair forms a part of a cable assembly that extends to the other component.

### BRIEF SUMMARY

Some embodiments are directed to an electrically conductive contact for use in an electrical connector. The electrically conductive contact electrically connects the contact of the electrical conductor and an electrical conductor of a cable.

The electrically conductive contact includes an elongated first portion extending along a first direction between a first free end and an opposite first joining end. The first portion comprises a first contact portion for making electrical contact with a contact of an electrical connector. The electrically conductive contact further includes an elongated second portion extending along a second direction, different from the first direction, between a second free end and an opposite second joining end. A joining portion joins the first and second joining ends of the first and second portions. A retaining portion is configured to retain the electrically conductive contact within the connector. The retaining portion extends along a third direction, different from the second direction, from a first middle location along the second portion to a third free end. The retaining and first portions may be disposed on a same side of the second portion. A cable connecting portion for making contact with an electrically conductive conductor of a cable extends along a fourth direction, different from the first, second, and third directions. The cable connecting portion extends from a second middle location along the second portion to a fourth free end. The cable connecting and retaining portions are disposed on opposite sides of the second portion.

According to some embodiments, an electrically conductive contact of an electrical connector includes an L-shaped main body comprising first and second legs connected at a junction. The first leg is configured to make physical and electrical contact with a first electric conductor. The contact includes an elongated resiliently flexible arm extending from an end of the second leg toward the junction and making an acute angle with the second leg at the end of the second leg. The flexible arm is configured to make solderless contact with a second electric conductor by pressing against the second electric conductor and resiliently flexing toward the second leg.

According to some embodiments, an electrically conductive contact of an electrical connector includes first and second L-shaped main bodies. Each main body comprises first and second legs connected at a junction. The first legs are substantially parallel to each other. The second legs are substantially collinear and extend away from each other. Each first leg is configured to make physical and electrical contact with a first electric conductor. A bridge connects the two junctions to each other. An elongated resiliently flexible arm extends from an end of each second leg toward the bridge and makes an acute angle with the second leg at the end of the second leg. Each flexible arm is configured to make solderless contact with a second electric conductor by pressing against the electric conductor and resiliently flexing toward the corresponding second leg.

Some embodiments are directed to an electrical connector. The electrical connector includes an electrically insulative housing comprising a top mating side for mating with a mating connector and an opposite bottom side. A plurality of electrically conductive contacts is disposed in the housing. Each contact comprises an elongated first portion, an elongated second portion, and an elongated resiliently flexible arm. The elongated first portion extends between the top and bottom sides of the housing. The first portion comprises a contact portion for making contact with a corresponding contact of an electrical mating connector. The elongated second portion extends along the bottom side of the housing. The elongated resiliently flexible arm extends from a first location along the second portion and makes an acute angle with the second portion at the first location. The flexible arm is configured to make solderless contact with an electric conductor by pressing against the electric conductor and resiliently flexing toward the second portion.

Some embodiments are directed to a connector assembly that includes the electrical connector described above. The connector assembly also includes a cable organizer disposed on the bottom side of the housing of the electrical connector. The cable organizer comprises a plurality of slots. Each slot accommodates the flexible arm of a different electrically conductive contact. The connector assembly also includes a cable comprising a plurality of electrical conductors. Each electrical conductor is disposed in a corresponding slot of the cable organizer. A press bar is removably assembled to the bottom side of the housing of the connector. The cable organizer is disposed between the housing and the press bar. The press bar comprises a plurality of grooves on a bottom surface thereof, each groove corresponding to and in line with a different slot of the cable organizer. The press bar presses the conductor in each groove against the corresponding flexible arm resulting in the flexible arm flexing toward the second portion corresponding to the flexible arm. Pressing each conductor in each groove against the corresponding flexible arm results in solderless electrical connection between the cable and the connector.

These and other aspects of the present application will be apparent from the detailed description below. In no event, however, should the above summaries be construed as limitations on the claimed subject matter, which subject matter is defined solely by the attached claims.

### BRIEF DESCRIPTION OF THE DRAWINGS

FIGS. 1A and 1B illustrate an electrically conductive contact for use in an electrical connector in accordance with some embodiments;

FIG. 2 illustrates an electrically conductive contact of an electrical connector in accordance with some embodiments;

FIG. 3 depicts another embodiment of an electrically conductive contact of an electrical connector in accordance with some embodiments;

FIGS. 4 and 5 illustrate an electrical connector in accordance with some embodiments;

FIG. 6 shows the contacts of the connector of FIGS. 4 and 5;

FIGS. 7A through 7D show various views of a press bar removably assembled to the bottom side of the housing of the connector of FIGS. 4 and 5; and

FIG. 8 illustrates a connector assembly in accordance with some embodiments.

The figures are not necessarily to scale. Like numbers used in the figures refer to like components. However, it will be understood that the use of a number to refer to a component in a given figure is not intended to limit the component in another figure labeled with the same number.

### DESCRIPTION OF ILLUSTRATIVE EMBODIMENTS

A generic cable assembly connector typically uses an intermediate printed circuit board (PCB) or paddle card to electrically and mechanically connect the cable to the corresponding mating connector. The cable is terminated on the surface of the PCB by soldering. This type of termination results in electrical loss and errors as signals travel longer distances on the PCB traces between the transmitting and receiving channels. The addition of the PCB and the soldering process also adds to the total cost of the cable assembly.

The approach described herein involves terminating the connector terminals to the cable conductors without soldering. The cable conductors and connector contacts are electrically connected together by pressing the connector contacts against the cable conductors. The embodiments disclosed herein are suitable for cable assembly connectors of various interfaces, such as mini serial attached small computer system interface (miniSAS) and peripheral component interface express (PCIe), among other connector interfaces. The approaches described herein facilitate realization and commercialization of miniaturized, high speed interconnect systems by providing lower electrical loss and reduced errors. According to approaches described herein, the PCB can be eliminated as a connector component.

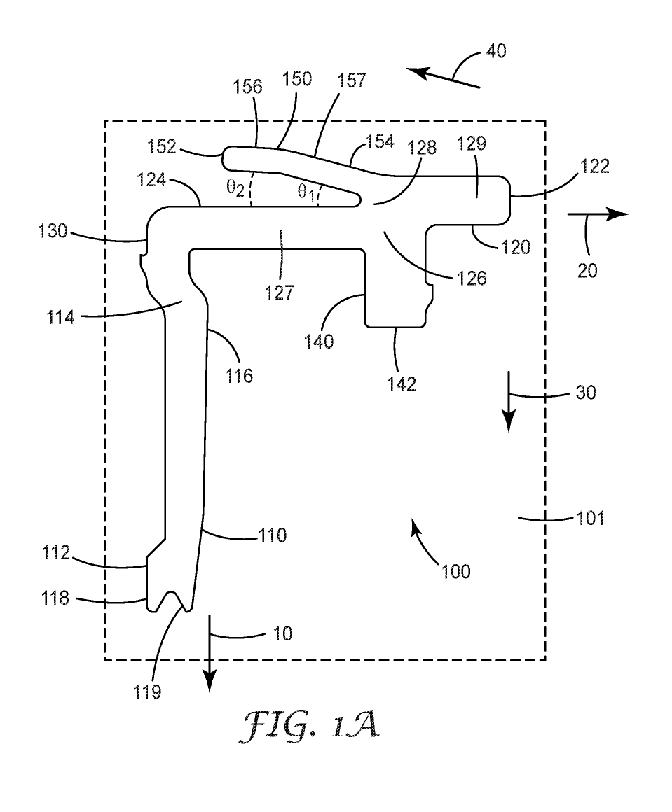

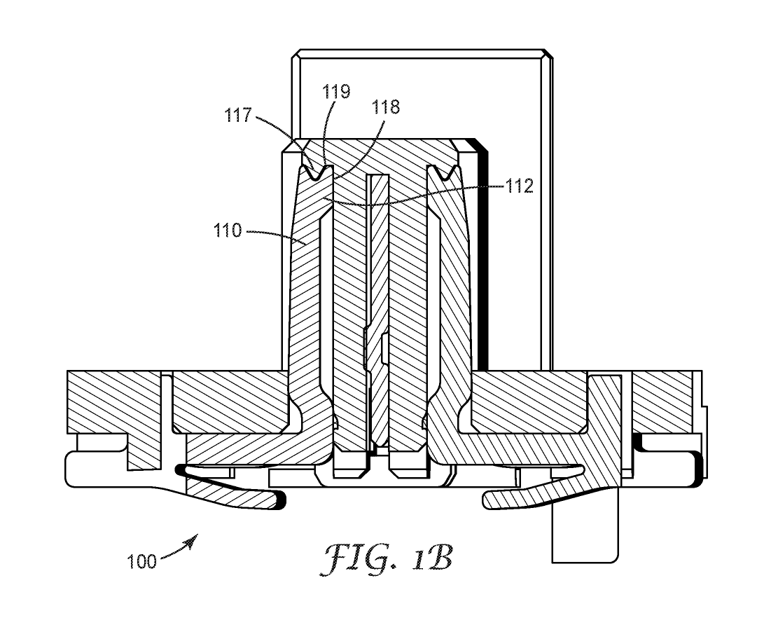

FIGS. 1A and 1B illustrate an electrically conductive contact 100 for use in an electrical connector. The electrically conductive contact 100 may be substantially planar, lying along plane 101, as indicated in FIG. 1A.

The contact 100 has an elongated first portion 110 extending along a first direction 10 between a first free end 112 and an opposite first joining end 114. The elongated first portion 110 comprises a first contact portion 116 configured to make contact with a contact of an electrical connector. The contact 100 includes an elongated second portion 120 that extends along a second direction 20, different from the first direction 10. In some embodiments, the second direction 20 is substantially perpendicular to the first direction 10. The second portion 120 extends between a second free end 122 and an opposite second joining end 124. As shown in FIG. 1A, the contact 100 includes a joining portion 130 configured to join the first 114 and second 124 joining ends of the first 110 and second 120 portions. A retaining portion 140 is configured to retain the electrically conductive contact 100 within a connector. The retaining portion 140 extends along a third direction 30, different from the second direction 20. The retaining portion 140 extends from a first middle location 126 along the second portion 120 to a third free end 142. The retaining 140 and first portions 110 are disposed on a same side of the second portion 120. The contact 100 includes a cable connecting portion 150 for making contact with an electrically conductive conductor of a cable (not shown in FIG. 1A) and extending along a fourth direction 40, different from the first 10, second 20, and third 30 directions. In some embodiments, the fourth direction 40 makes an acute angle (θ₁) with the second portion 120 at a second middle location 128. In some embodiments, cable connecting portion 150 extends from the second middle location 128 toward the joining portion 130. The first 126 and second 128 middle locations may be substantially coincident with each other in some embodiments.

The cable connecting portion 150 can extend from a second middle location 128 along the second portion 120 to a fourth free end 152. The cable connecting 150 and retaining 140 portions may be disposed on opposite sides of the second portion 120.

As indicated in FIG. 1A, in some embodiments the cable connecting portion 150 includes a first connecting portion 154 attached to and making a first acute angle θ₁ with the second portion 120 at the second middle location 128. The cable connecting portion 150 may also include a second connecting portion 156 that extends from an end 157 of the first connecting portion 154 to the fourth free end 152. In some configurations, the second connecting portion 156 makes a second acute angle θ₂, smaller than the first acute angle, with the second portion 120. The cable connecting portion 150 may be resiliently flexible and configured to resiliently flex toward the second portion 120 when pressed against an electrically conductive conductor of a cable. The cable connecting portion 150 can be configured to solderlessly make contact with an electrically conductive conductor when flexed by the conductor.

According to some implementations, a longitudinal end 118 of the elongated first portion 110 at the first free end 112 comprises a locking profile 119, such that when the contact is mounted in an electrical connector, the locking profile 119 engages a complementary locking profile 117 (see FIG. 1B) of the connector to secure the contact 100 in the connector. For example, the locking profile 119 may V-shaped.

According to some embodiments, the elongated second portion 120 includes an elongated longer portion 127 that extends from the second joining portion 124 and an elongated shorter portion 129 that extends between the longer portion 127 and the second free end 122. The shorter portion 129 is offset relative to the longer portion 127 along the first direction 10.

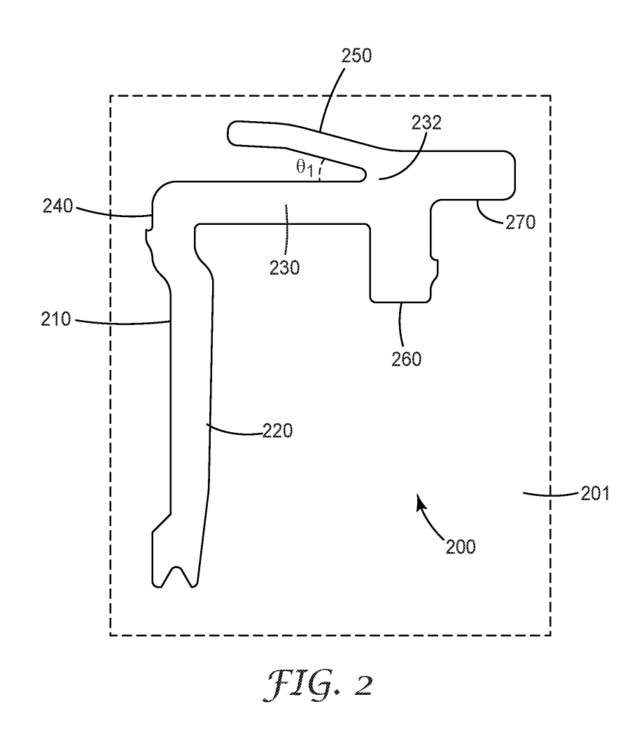

FIG. 2 illustrates an electrically conductive contact 200 of an electrical connector in accordance with some embodiments. The contact 200 includes an L-shaped main body 210 comprising first 220 and second 230 legs connected at a junction 240. The electrically conductive contact 200 may be substantially planar, lying along plane 201, as indicated in FIG. 2.

The first leg 220 is configured to make physical and electrical contact with a first electric conductor. An elongated resiliently flexible arm 250 extends from an end 232 of the second leg 230 toward the junction 240 and making an acute angle (θ₁) with the second leg 230 at the end 232 of the second leg 230. The first leg 220 and the resiliently flexible arm 250 may be arranged on opposite sides of the second leg 230 as shown in FIG. 2. The flexible arm 250 is configured to make solderless contact with a second electric conductor by pressing against the second electric conductor and resiliently flexing toward the second leg 230. In some embodiments, the second leg 230 is longer than the elongated resiliently flexible arm 250.

According to some implementations, the contact 200 includes a retaining portion 260 that extends from the end 232 of the second leg 230 and is parallel to the first leg 220. The retaining portion 260 is configured to retain the electrically conductive contact within a connector. The contact 200 may include an extension portion 270 that extends from the end 232 of the second leg 230. The extension portion 270 can be parallel to the second leg 230 and offset relative to the second leg 230 in a direction parallel to the first leg 220.

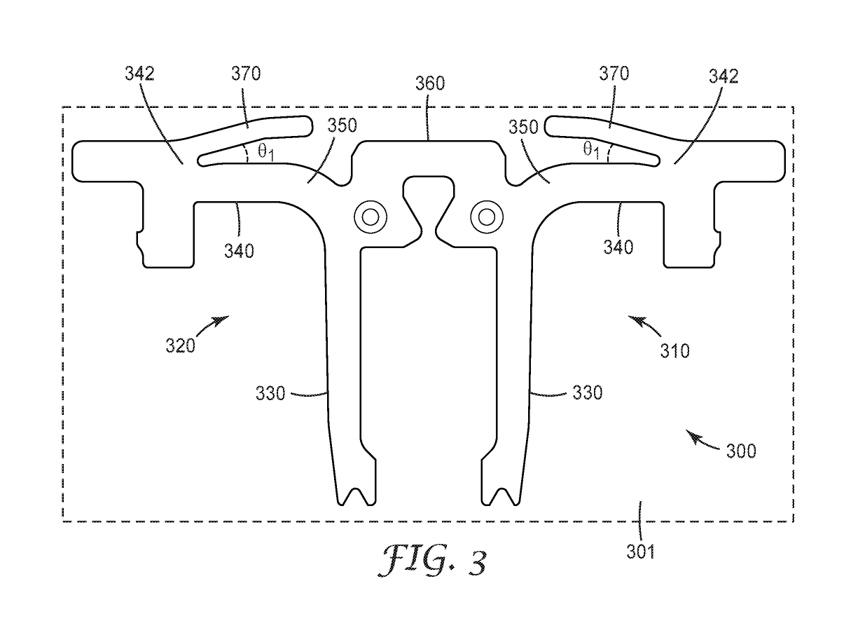

FIG. 3 depicts another embodiment of an electrically conductive contact 300 of an electrical connector in accordance with some embodiments. The electrically conductive contact 300 may be substantially planar, lying along plane 301, as indicated in FIG. 3.

The contact 300 includes first 310 and second 320 L-shaped main bodies. Each main body 310, 320 includes first 330 and second 340 legs connected at a junction 350. Each first leg 330 is configured to make physical and electrical contact with an electric conductor. The first legs 330 are substantially parallel to each other. The second legs 340 are substantially collinear and extend away from each other. The contact 300 includes a bridge 360 that connects the two junctions 350 to each other. An elongated resiliently flexible arm 370 extends from an end 342 of each second leg 340 toward the bridge 350. The elongated flexible arm 370 makes an acute angle θ₁ with the second leg 340 at the end 342 of the second leg. Each flexible arm 370 is configured to make solderless contact with an electric conductor by pressing against the electric conductor and resiliently flexing toward the corresponding second leg 340.

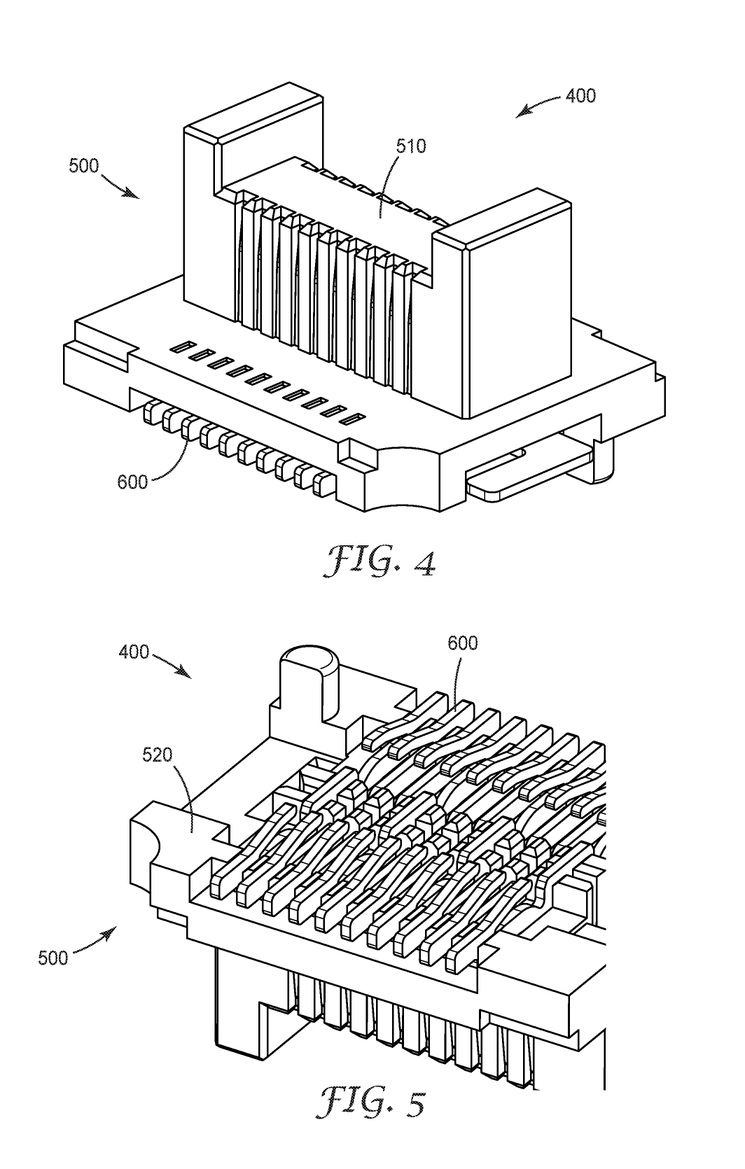

FIGS. 4 and 5 illustrate an electrical connector 400 in accordance with some embodiments. The connector 400 includes an electrically insulative housing 500 comprising a top mating side 510 for mating with a mating connector and an opposite bottom side 520. A plurality of electrically conductive contacts 600 are disposed in the housing 500.

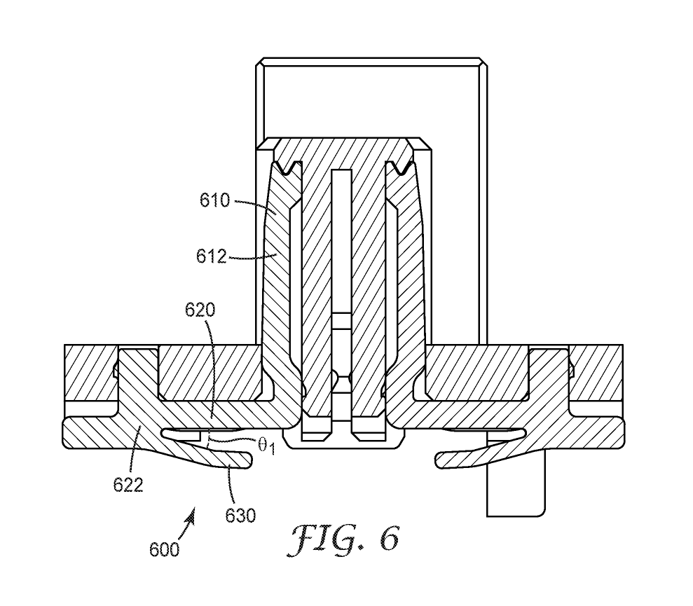

FIG. 6 shows the contacts 600 of the connector 400. Each contact 600 includes an elongated first portion 610 extending between the top 510 and bottom 520 sides of the housing 500. The first portion 610 comprises a contact portion 612 configured to make contact with a corresponding contact of an electrical mating connector. The contacts 600 include an elongated second portion 620 extending along the bottom side 520 of the housing 500. An elongated resiliently flexible arm 630 extends from a first location 622 along the second portion 620 and makes an acute angle θ₁ with the second portion 620 at the first location 622. The flexible arm 630 is configured to make solderless contact with an electric conductor by pressing against the electric conductor and resiliently flexing toward the second portion 620. In some embodiments, the second portion 620 does not move or flex when the resiliently flexible arm 630 flexes toward the second portion 620.

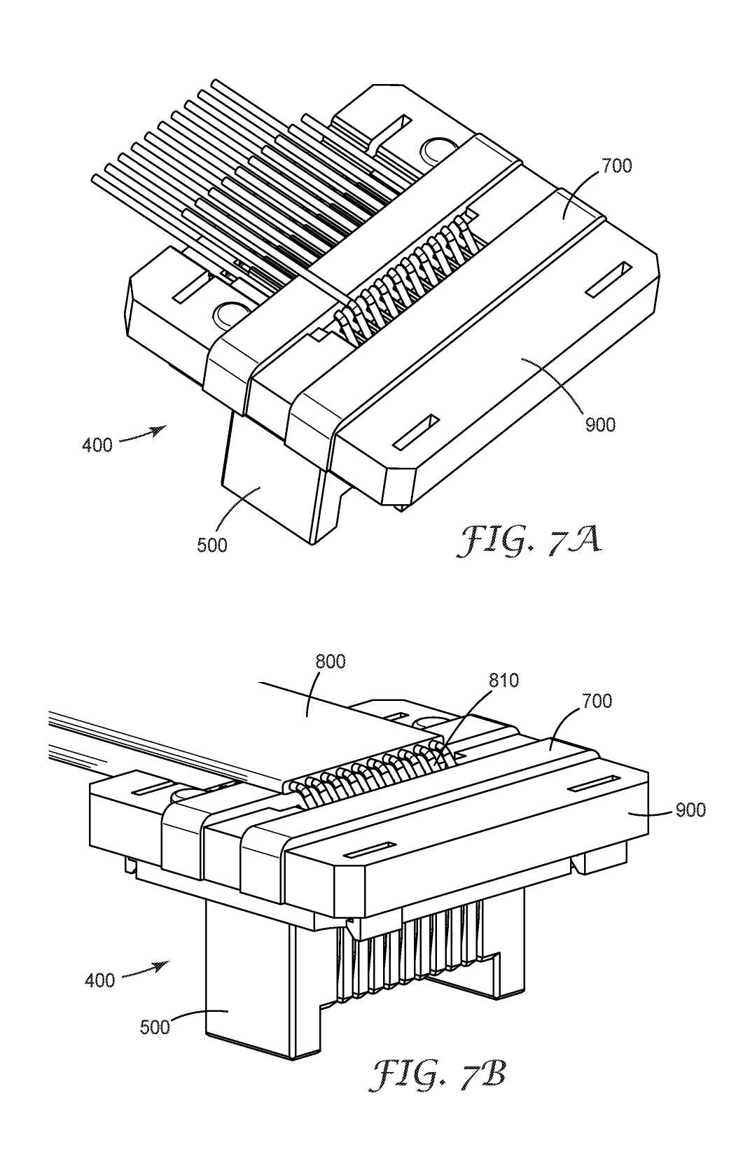

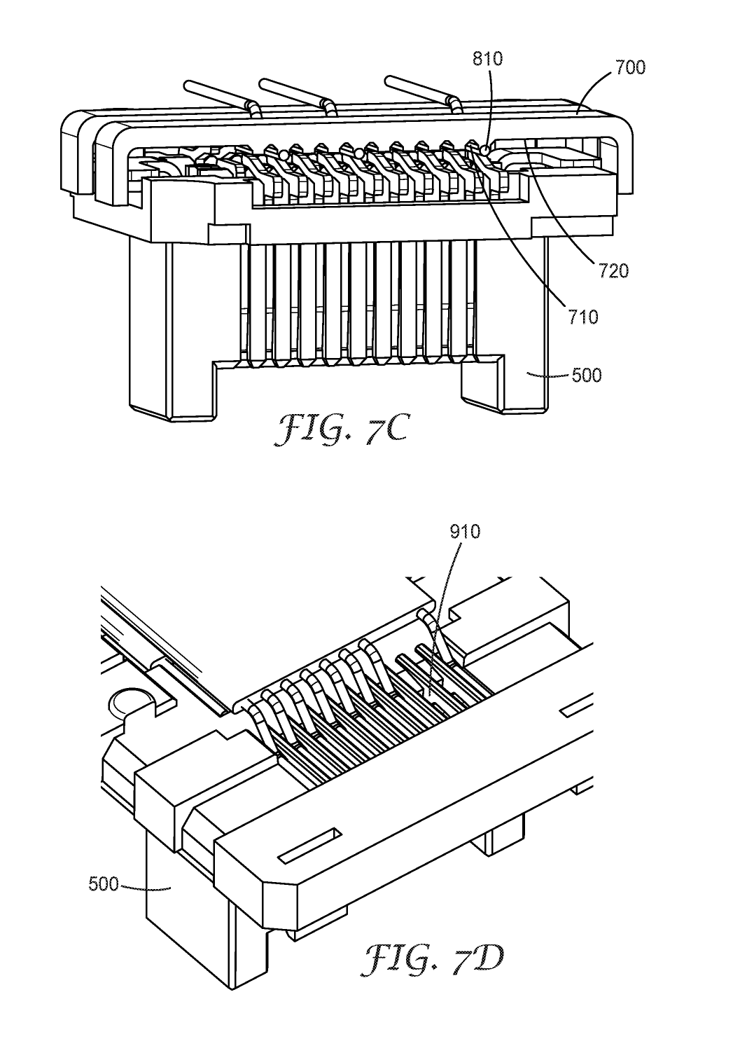

As shown in the various views of FIGS. 7A through 7D, a press bar 700 may be removably assembled to the bottom side 520 of the housing 500 of the connector 400. The press bar 700 comprises a plurality of grooves 710 on a bottom surface 720 thereof. Each groove 710 corresponds to and is in line with the flexible arm 630 of a different conductive contact 600. Each groove 710 is configured to receive a conductor 810 of a cable 800. When each groove 710 receives a different conductor 810 of a cable 800 and the press bar 700 is assembled to the housing 500, the press bar 700 presses the conductor 810 in each groove 710 against the corresponding flexible arm 630. Pressing the conductor 810 in each groove 710 against the corresponding flexible arm 630 causes the flexible arm 630 to flex toward the second portion 620 corresponding to the flexible arm 630 producing a solderless electrical connection between the cable 800 and the connector 400.

In some embodiments, the connector further includes a cable organizer 900 disposed on the bottom side 520 of the housing 500. The cable organizer 900 comprises a plurality of slots 910. Each slot 910 corresponds to and is in line with the flexible arm 630 of a different conductive contact 600 and is configured to receive a conductor 810 of a cable 800.

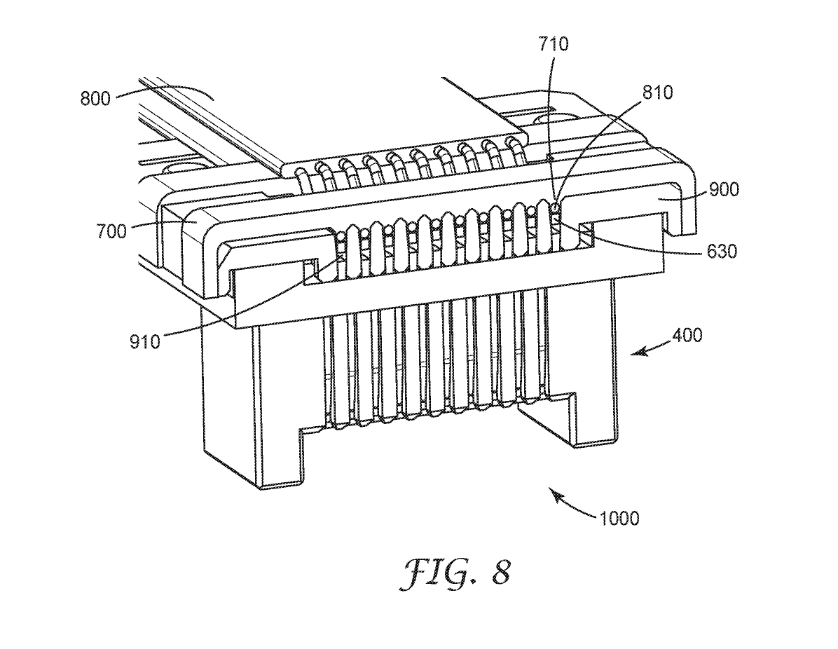

Some embodiments are directed to a connector assembly 1000 as shown in FIG. 8. The connector assembly includes an electrical connector 400 as described above and as shown in FIGS. 4 through 6. The connector assembly further includes a cable organizer 900 disposed on the bottom side 520 of the housing 500 (see FIG. 5) and comprising a plurality of slots 910. Each slot 910 accommodates the flexible arm 630 of a different conductive contact 600 (see FIG. 6). As shown in FIG. 8, the connector assembly 1000 includes a cable 800 comprising a plurality of conductors 810, wherein each conductor 810 is disposed in a corresponding slot 910 of the cable organizer 900. The connector assembly 1000 includes a press bar 700 removably assembled to the bottom side 520 of the housing 500. The cable organizer 900 is disposed between the housing 500 and the press bar 700. The press bar 700 comprises a plurality of grooves 710 on a bottom surface of the press bar 700. Each groove 710 corresponds to and is in line with a different slot 910 of the cable organizer 900. The press bar 700 is configured to press the conductor 810 in each groove 810 against the corresponding flexible arm 630 resulting in the flexible arm 630 flexing toward the second portion 620 corresponding to the flexible arm 630 resulting in solderless electrical connection between the cable 800 and the connector 400.

Embodiments disclosed herein include:

### Embodiment 1

An electrically conductive contact for use in an electrical connector, comprising:

an elongated first portion extending along a first direction between a first free end and an opposite first joining end, the first portion comprising a first contact portion for making contact with a contact of an electrical connector;

an elongated second portion extending along a second direction, different from the first direction, between a second free end and an opposite second joining end;

a joining portion joining the first and second joining ends of the first and second portions;

a retaining portion for retaining the electrically conductive contact within a connector and extending along a third direction, different from the second direction, from a first middle location along the second portion to a third free end, the retaining and first portions on a same side of the second portion; and

a cable connecting portion for making contact with an electrically conductive conductor of a cable and extending along a fourth direction, different from the first, second and third directions, from a second middle location along the second portion to a fourth free end, the cable connecting and retaining portions on opposite sides of the second portion.

### Embodiment 2

The electrically conductive contact of embodiment 1 being substantially planar.

### Embodiment 3

The electrically conductive contact of any of embodiments 1 through 2, wherein the second direction is substantially perpendicular to the first direction.

### Embodiment 4

The electrically conductive contact of any of embodiments 1 through 3, wherein the fourth direction makes an acute angle with the second portion at the second middle location and the cable connecting portion extends from the second middle location toward the joining portion.

### Embodiment 5

The electrically conductive contact of any of embodiments 1 through 4, wherein the first and second middle locations are substantially coincident with each other.

### Embodiment 6

The electrically conductive contact of any of embodiments 1 through 5, wherein the cable connecting portion comprises:

a first connecting portion attached to and making a first acute angle with the second portion at the second middle location; and

a second connecting portion extending from an end of the first connecting portion to the fourth free end and making a second acute angle, smaller than the first acute angle, with the second portion.

### Embodiment 7

The electrically conductive contact of any of embodiments 1 through 6, wherein the cable connecting portion is resiliently flexible and configured to resiliently flex toward the second portion when pressed against an electrically conductive conductor of a cable.

### Embodiment 8

The electrically conductive contact of any of embodiments 1 through 7, wherein the cable connecting portion is resiliently flexible and configured to solderlessly make contact with an electrically conductive conductor when flexed by the conductor.

### Embodiment 9

The electrically conductive contact of any of embodiments 1 through 8, wherein a longitudinal end of the elongated first portion at the first free end comprises a locking profile, such that when the contact is mounted in an electrical connector, the locking profile engages a complementary locking profile of the connector to secure the contact in the connector.

### Embodiment 10

The electrically conductive contact of embodiment 9, wherein the locking profile is V-shaped.

### Embodiment 11

The electrically conductive contact of any of embodiments 1 through 10, wherein the elongated second portion comprises:

an elongated longer portion extending from the second joining portion; and

an elongated shorter portion extending between the longer portion and the second free end, the shorter portion offset relative to the longer portion along the first direction.

### Embodiment 12

An electrically conductive contact of an electrical connector, comprising:

an L-shaped main body comprising first and second legs connected at a junction, the first leg configured to make physical and electrical contact with a first electric conductor; and

an elongated resiliently flexible arm extending from an end of the second leg toward the junction and making an acute angle with the second leg at the end of the second leg, the flexible arm configured to make solderless contact with a second electric conductor by pressing against the second electric conductor and resiliently flexing toward the second leg.

### Embodiment 13

The electrically conductive contact of embodiment 12, wherein the first leg and the resiliently flexible arm are on opposite sides of the second leg.

### Embodiment 14

The electrically conductive contact of any of embodiments 12 through 13 being planar.

### Embodiment 15

The electrically conductive contact of any of embodiments 12 through 14 further comprising:

a retaining portion extending from the end of the second leg parallel to the first leg and configured to retain the electrically conductive contact within a connector; and

an extension portion extending from the end of the second leg parallel to the second leg and offset relative to the second leg in a direction parallel to the first leg.

### Embodiment 16

The electrically conductive contact of any of embodiments 12 through 15, wherein the second leg is longer than the elongated resiliently flexible arm.

### Embodiment 17

An electrically conductive contact of an electrical connector, comprising:

first and second L-shaped main bodies, each main body comprising first and second legs connected at a junction, the first legs being substantially parallel to each other, the second legs being substantially collinear and extending away from each other, each first leg configured to make physical and electrical contact with an electric conductor;

a bridge connecting the two junctions to each other; and

an elongated resiliently flexible arm extending from an end of each second leg toward the bridge and making an acute angle with the second leg at the end of the second leg, each flexible arm configured to make solderless contact with an electric conductor by pressing against the electric conductor and resiliently flexing toward the corresponding second leg.

### Embodiment 18

The electrically conductive contact of embodiment 17 being substantially planar.

### Embodiment 19

An electrical connector comprising:

an electrically insulative housing comprising a top mating side for mating with a mating connector and an opposite bottom side; and

a plurality of electrically conductive contacts disposed in the housing, each contact comprising:
an elongated first portion extending between the top and bottom sides of the housing, the first portion comprising a contact portion for making contact with a corresponding contact of an electrical mating connector;
an elongated second portion extending along the bottom side of the housing; and
an elongated resiliently flexible arm extending from a first location along the second portion and making an acute angle with the second portion at the first location, the flexible arm configured to make solderless contact with an electric conductor by pressing against the electric conductor and resiliently flexing toward the second portion.

### Embodiment 20

The electrical connector of embodiment 19, wherein the second portion does not move or flex when the resiliently flexible arm flexes toward the second portion.

### Embodiment 21

The electrical connector of any of embodiments 19 through 20 further comprising a press bar removably assembled to the bottom side of the housing and comprising a plurality of grooves on a bottom surface thereof, each groove corresponding to and in line with the flexible arm of a different conductive contact and configured to receive a conductor of a cable, such that when each groove receives a different conductor of a cable and the press bar is assembled to the housing, the press bar presses the conductor in each groove against the corresponding flexible arm resulting in the flexible arm flexing toward the second portion corresponding to the flexible arm resulting in solderless electrical connection between the cable and the connector.

### Embodiment 22

The electrical connector of any of embodiments 19 through 21 further comprising a cable organizer disposed on the bottom side of the housing and comprising a plurality of slots, each slot corresponding to and in line with the flexible arm of a different conductive contact and configured to receive a conductor of a cable.

### Embodiment 23

A connector assembly, comprising:

the electrical connector of embodiment 19;

a cable organizer disposed on the bottom side of the housing and comprising a plurality of slots, each slot accommodating the flexible arm of a different conductive contact;

a cable comprising a plurality of conductors, each conductor disposed in a corresponding slot of the cable organizer; and

a press bar removably assembled to the bottom side of the housing, the cable organizer disposed between the housing and the press bar, the press bar comprising a plurality of grooves on a bottom surface thereof, each groove corresponding to and in line with a different slot of the cable organizer, the press bar pressing the conductor in each groove against the corresponding flexible arm resulting in the flexible arm flexing toward the second portion corresponding to the flexible arm resulting in solderless electrical connection between the cable and the connector.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Various modifications and alterations of these embodiments will be apparent to those skilled in the art and it should be understood that this scope of this disclosure is not limited to the illustrative embodiments set forth herein. For example, the reader should assume that features of one disclosed embodiment can also be applied to all other disclosed embodiments unless otherwise indicated.

1-10. (canceled)

11. An electrically conductive contact for use in an electrical connector, comprising:
an elongated first portion extending along a first direction between a first free end and an opposite first joining end, the first portion comprising a first contact portion for making contact with a contact of an electrical connector;
an elongated second portion extending along a second direction, different from the first direction, between a second free end and an opposite second joining end;
a joining portion joining the first and second joining ends of the first and second portions;
a retaining portion for retaining the electrically conductive contact within a connector and extending along a third direction, different from the second direction, from a first middle location along the second portion to a third free end, the retaining and first portions on a same side of the second portion; and
a cable connecting portion for making contact with an electrically conductive conductor of a cable and extending along a fourth direction, different from the first, second and third directions, from a second middle location along the second portion to a fourth free end, the cable connecting and retaining portions on opposite sides of the second portion.

12. The electrically conductive contact of claim 11 being substantially planar.

13. The electrically conductive contact of claim 11, wherein the fourth direction makes an acute angle with the second portion at the second middle location and the cable connecting portion extends from the second middle location toward the joining portion.

14. The electrically conductive contact of claim 11, wherein the first and second middle locations are substantially coincident with each other.

15. The electrically conductive contact of claim 11, wherein the cable connecting portion comprises:
a first connecting portion attached to and making a first acute angle with the second portion at the second middle location; and
a second connecting portion extending from an end of the first connecting portion to the fourth free end and making a second acute angle, smaller than the first acute angle, with the second portion.

16. The electrically conductive contact of claim 11, wherein the cable connecting portion is resiliently flexible and configured to resiliently flex toward the second portion when pressed against an electrically conductive conductor of a cable.

17. The electrically conductive contact of claim 11, wherein the cable connecting portion is resiliently flexible and configured to solderlessly make contact with an electrically conductive conductor when flexed by the conductor.

18. The electrically conductive contact of claim 11, wherein a longitudinal end of the elongated first portion at the first free end comprises a locking profile, such that when the contact is mounted in an electrical connector, the locking profile engages a complementary locking profile of the connector to secure the contact in the connector.

19. The electrically conductive contact of claim 11, wherein the elongated second portion comprises:
an elongated longer portion extending from the second joining portion; and
an elongated shorter portion extending between the longer portion and the second free end, the shorter portion offset relative to the longer portion along the first direction.

20. An electrically conductive contact of an electrical connector, comprising:
an L-shaped main body comprising first and second legs connected at a junction, the first leg configured to make physical and electrical contact with a first electric conductor; and
an elongated resiliently flexible arm extending from an end of the second leg toward the junction and making an acute angle with the second leg at the end of the second leg, the flexible arm configured to make solderless contact with a second electric conductor by pressing against the second electric conductor and resiliently flexing toward the second leg.

21. The electrically conductive contact of claim 20, wherein the first leg and the resiliently flexible arm are on opposite sides of the second leg.

22. The electrically conductive contact of claim 20 being planar.

23. The electrically conductive contact of claim 20 further comprising:
a retaining portion extending from the end of the second leg parallel to the first leg and configured to retain the electrically conductive contact within a connector; and
an extension portion extending from the end of the second leg parallel to the second leg and offset relative to the second leg in a direction parallel to the first leg.

24. An electrically conductive contact of an electrical connector, comprising:
first and second L-shaped main bodies, each main body comprising first and second legs connected at a junction, the first legs being substantially parallel to each other, the second legs being substantially collinear and extending away from each other, each first leg configured to make physical and electrical contact with an electric conductor;
a bridge connecting the two junctions to each other; and
an elongated resiliently flexible arm extending from an end of each second leg toward the bridge and making an acute angle with the second leg at the end of the second leg, each flexible arm configured to make solderless contact with an electric conductor by pressing against the electric conductor and resiliently flexing toward the corresponding second leg.

25. The electrically conductive contact of claim 24 being substantially planar.

26. An electrical connector comprising:
an electrically insulative housing comprising a top mating side for mating with a mating connector and an opposite bottom side; and
a plurality of electrically conductive contacts disposed in the housing, each contact comprising:
an elongated first portion extending between the top and bottom sides of the housing, the first portion comprising a contact portion for making contact with a corresponding contact of an electrical mating connector;
an elongated second portion extending along the bottom side of the housing; and
an elongated resiliently flexible arm extending from a first location along the second portion and making an acute angle with the second portion at the first location, the flexible arm configured to make solderless contact with an electric conductor by pressing against the electric conductor and resiliently flexing toward the second portion.

27. The electrical connector of claim 26, wherein the second portion does not move or flex when the resiliently flexible arm flexes toward the second portion.

28. The electrical connector of claim 26 further comprising a press bar removably assembled to the bottom side of the housing and comprising a plurality of grooves on a bottom surface thereof, each groove corresponding to and in line with the flexible arm of a different conductive contact and configured to receive a conductor of a cable, such that when each groove receives a different conductor of a cable and the press bar is assembled to the housing, the press bar presses the conductor in each groove against the corresponding flexible arm resulting in the flexible arm flexing toward the second portion corresponding to the flexible arm resulting in solderless electrical connection between the cable and the connector.

29. The electrical connector of claim 26 further comprising a cable organizer disposed on the bottom side of the housing and comprising a plurality of slots, each slot corresponding to and in line with the flexible arm of a different conductive contact and configured to receive a conductor of a cable.

30. A connector assembly, comprising:
the electrical connector of claim 26;
a cable organizer disposed on the bottom side of the housing and comprising a plurality of slots, each slot accommodating the flexible arm of a different conductive contact;
a cable comprising a plurality of conductors, each conductor disposed in a corresponding slot of the cable organizer; and
a press bar removably assembled to the bottom side of the housing, the cable organizer disposed between the housing and the press bar, the press bar comprising a plurality of grooves on a bottom surface thereof, each groove corresponding to and in line with a different slot of the cable organizer, the press bar pressing the conductor in each groove against the corresponding flexible arm resulting in the flexible arm flexing toward the second portion corresponding to the flexible arm resulting in solderless electrical connection between the cable and the connector.
